(19) United States
(12) Patent Application Publication
(10) Pub. No.: US 2026/0213370 A1
(43) Pub. Date: Jul. 23, 2026

(54) SECONDARY CELL

(71) Applicant: Northvolt AB, Stockholm (SE)

(72) Inventor: Dongho Son, Stockholm (SE)

(21) Appl. No.: 19/142,209

(22) PCT Filed: Dec. 20, 2023
(86) PCT No.: PCT/EP2023/086876

§ 371 Date: Jun. 22, 2025

(30) Foreign Application Priority Data
Dec. 23, 2022 (SE) 2251575-3

(51) Int. Cl. H01M 50/538; H01M 10/04; H01M 50/107; H01M 50/533; H01M 50/536; H01M 50/545; H01M 50/566; H01M 50/627

(52) U.S. Cl. CPC H01M 50/538; H01M 10/0431; H01M 50/107; H01M 50/533; H01M 50/536; H01M 50/545; H01M 50/566; H01M 50/627

(57) ABSTRACT

There is disclosed herein a cylindrical secondary cell (1) and method of manufacture thereof. The cylindrical secondary cell comprises a cylindrical can (2) having a beading groove (3) formed in a wall thereof and arranged around the circumference thereof. The cell (1) further comprises a first conductive sheet (4), with first electrode coating (4a), wound to form a jelly roll (5) which is arranged in the can (2). The first conductive sheet (4) comprises a portion free of first electrode coating (4a) which protrudes and axially extends from a first end side (5a) of the jelly roll (5) arranged below the beading groove (3), to a can connection surface (9) above the beading groove (9). The can connection surface (9) is arranged at the first end side (5a) of the jelly roll (5) and configured to form an electrical connection from the jelly roll (5) to the can (2), by attachment of the can connection surface (9) to the portion of the first conductive sheet (4) free of first electrode coating (4a).

### TECHNICAL FIELD

The present disclosure generally pertains to secondary cells and more precisely to a secondary cell, where a current collector disc is welded to the foil of an electrode roll without first flattening said foil.

### BACKGROUND

In addressing climate change, there is an increasing demand for rechargeable batteries, e.g., to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

In view of at least the above considerations, there is provided, according to aspects of the present disclosure, an arrangement In particular, according to an aspect of the present disclosure, there is provided a cylindrical secondary cell comprising a cylindrical can having a beading groove formed in a wall of the cylindrical can and arranged around the circumference of the cylindrical can. The cylindrical secondary cell further comprises a first conductive sheet, with first electrode coating, wound to form a jelly roll which is arranged in the cylindrical can.

The first conductive sheet comprises a portion free of first electrode coating which protrudes and axially extends from a first end side of the jelly roll arranged below (i.e., axially below, away from the lid of the cell) the beading groove, to a can connection surface above the beading groove.

Furthermore, the can connection surface is arranged at the first end side of the jelly roll and configured to form an electrical connection from the jelly roll to the cylindrical can, by attachment of the can connection surface to the portion of the first conductive sheet free of first electrode coating.

The can connection surface may be on (e.g., an inner underside of) a current collector disc or a lid configured to be attached to the cylindrical can to thereby close an open end of the cylindrical can, depending on the implementation.

According to such an approach, the manufacture of the secondary cell can be greatly simplified. For example, according to the presently disclosed approach, by allowing the uncoated portion of the jelly roll to protrude and axially extends from a first end side of the jelly roll, a flattening process for the jelly roll, including a notching or slitting of the conductive sheet, can be advantageously skipped. Furthermore, by not flattening the uncoated portion of the conductive sheet, the flow of electrolyte is advantageously less impeded, e.g., from an electrolyte filling hole arranged on the external of the cylindrical cell.

In some examples, the connection surface is welded to the portion of the first conductive sheet free of first electrode coating.

The current collector disc may be in direct contact with the lid and/or the cylindrical can, in some example implementations.

The jelly roll may be axially retained within the cylindrical can by the beading groove. That is, the radius of the substantially cylindrical jelly roll may be greater than that defined by the innermost edge of the beading groove (i.e., the apex of the beading groove). Hence, axial motion of the jelly roll may be advantageously mitigated by the beading groove.

In an example implementation, an inner surface of the beading groove may be provided with a coating, such as a tape, so as to electrically insulate the beading groove from the jelly roll and/or to mechanically dampen the contact between these components are thereby reduce the risk of damage to the jelly roll during axial motion thereof. It will be appreciated that a separator sheet in the jelly may assist in protecting the jelly roll from undesired electrical contact with the inside of the cylindrical can.

In some examples, the current collector disc and/or the lid comprises at least one through hole for electrolyte filling, and in some further examples, the portion of the first conductive sheet free of first electrode coating is configured to form one or more electrolyte channels. Thus, electrolyte may be added to the secondary cell via the through hole and may be guided within the jelly roll by the one or more electrolyte channels formed by the uncoated and unflattened portion of the first conductive sheet. In some examples, the through hole for electrolyte filling is aligned with the one or more electrolyte channels.

According to a further aspect of the present disclosure, there is provided a method for manufacturing the secondary cell substantially as described above. The method comprises arranging the can connection surface against the portion of the first conductive sheet free of first electrode coating, and welding the can connection surface to the portion of the first conductive sheet free of first electrode coating.

In an example refinement of the method, a further step is performed, of compressing the can connection surface against the portion of the first conductive sheet free of first electrode coating to thereby form a folded welding surface for welding the can connection surface to the portion of the first conductive sheet free of first electrode coating. Thus, a greater surface area is provided for welding the can connection surface to the uncoated portion of the first conductive sheet.

### BRIEF DESCRIPTION OF THE DRAWINGS

Aspects of the present disclosure will be described, by way of example only, and with reference to the following figures, in which:

FIG. 1 shows a cross-sectional view of an example cylindrical secondary cell wherein the jelly roll is secured in place in the cylindrical can

FIG. 2 shows a cross-sectional view of another example cylindrical secondary cell wherein the jelly roll is secured in place in the cylindrical can by a beading groove.

### DETAILED DESCRIPTION

The present disclosure is described in the following by way of a number of illustrative examples. It will be appreciated that these examples are provided for illustration and explanation only and are not intended to be limiting on the scope of the disclosure.

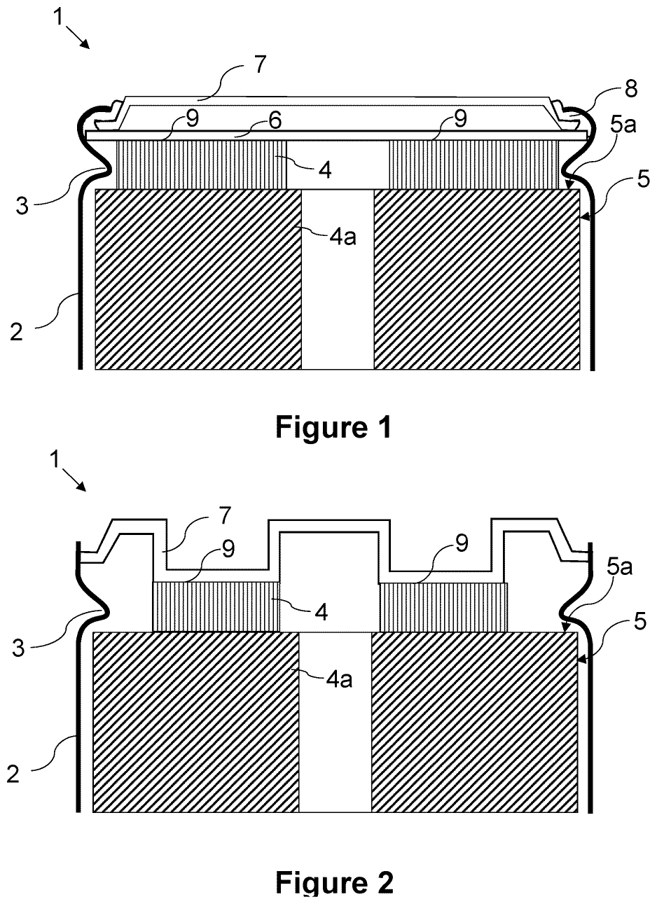

FIG. 1 shows a cross-sectional view of an example cylindrical secondary cell 1, wherein a current collector disc 6 (which may also be referred to as an ‘electrode lead plate’) is arranged in the cylindrical can 2 above a beading groove 3, and a jelly roll 5 is arranged below the beading groove 3.

The cylindrical secondary cell 1 comprises a cylindrical can 2 (also referred to simply as the ‘can 2’) having a beading groove 3 formed in a sidewall of the cylindrical can 2 and arranged around the circumference thereof.

The cylindrical secondary cell 1 further comprises a first conductive sheet 4, with first electrode coating 4a wound to form a jelly roll 5 which is arranged in the can 2.

In some examples, the cylindrical secondary cell 1 comprises a second conductive sheet with second electrode coating. The cylindrical secondary cell 1 may also comprise a separator sheet. The first conductive sheet 4 and the second conductive sheet, and optionally, the separator sheet, are wound to form the jelly roll 5. Alternatively, there are two separator sheets so that the first conductive sheet 4, a first separator sheet, the second conductive sheet and a second separator sheet are wound to form the jelly roll 5. It may also be the case that there is no separator sheet, for example if a solid electrolyte is used in the cylindrical secondary cell 1. For the purpose of the present disclosure, only the first conductive sheet 4, with first electrode coating 4a, is The first conductive sheet 4 comprises a portion free of first electrode coating 4a which protrudes on a first end side 5a of the jelly roll 5. Such a cylindrical secondary cell 1, with uncoated conductive sheet protruding on the end side of the jelly roll 5 is known as a ‘tabless cell’.

The cylindrical secondary cell 1 further comprises a current collector disc 6 which is electrically conductive and arranged at the first end side 5a of the jelly roll 5 and in direct contact with at least part of the portion free of first electrode coating 4a of the first conductive sheet 4. In other words, and as can be seen in FIG. 1, the current collector disc 6 is arranged in the cylindrical can 2 directly against, and abutting, the at least part of the portion free of first electrode coating 4a of the first conductive sheet 4. The current collector disc 6 is arranged in direct electrical and physical contact with the first conductive sheet 4.

The portion free of first electrode coating 4a protrudes and axially extends from a first end side 5a of the jelly roll 5, arranged below the beading groove 3, to a can connection surface 9 above (i.e., axially above) the beading groove 3. The can connection surface 9 is formed by an underside of the current collector disc 6 and provides a current path from the jelly roll 5 to the can 2, i.e., via electrical contact of the current collector disc 6 to the can 2. In some examples, the current collector disc 6 comprises a peripheral flange to increase the contact area between the current collector disc 6 and the cylindrical can 2.

That is, as illustrated in FIG. 1, the portion free of first electrode coating 4a is not flattened before the current collector disc 6 is introduced.

Accordingly the step of notching/slitting the uncoated part of the conductive sheet 4 and then flattening the uncoated portion of the conductive sheet 4 can be advantageously skipped.

The cell 1 further comprises a lid 7 arranged to close an open end of the cylindrical can 2. The lid 7 in this example is crimped with a gasket 8 arranged therearound so as to form a watertight seal of the cylindrical can 2. In an example, the current collector disc 6 may not contact the side of separate terminal may be arranged thereon, depending on the implementation.

The current collector disc 6 may be welded to the beading groove 3, such as by using laser welding. Welding the current collector disc 6 to the cylindrical can 2 at the beading groove 3 may comprise directing a welding laser into an open end of the cylindrical can 2 such that a weld is formed on a surface of the beading groove 3 that faces said open end of the cylindrical can 2.

Additionally or alternatively, welding the current collector disc 6 to the cylindrical can 2 may comprise directing a welding laser at an outer surface of the beading groove 3.

FIG. 2 shows an alternative configuration for a secondary cell 1, wherein the lid 7 is welded (e.g., laser welded) to the cylindrical can 2 to thereby close the cylindrical can 2, without a gasket being arranged therearound, and without a current collector disc. That is, in the example shown in FIG. 2, the lid 7 serves as the current collector through a direct electrical connection to the uncoated portion of the conductive sheet 4 of the jelly roll 5.

As illustrated in FIG. 2, the portion free of first electrode coating 4a protrudes and axially extends from a first end side 5a of the jelly roll 5, arranged below the beading groove 3, to a can connection surface 9 above the beading groove 3. The can connection surface 9 in this example is formed by an underside of the lid 7 and provides a current path from the jelly roll 5 to the can 2, i.e., via electrical contact of the lid 7 to the can 2. In the illustrated example, lid 7 comprises a plurality of recesses that form a contact area between the lid 7 and the jelly roll 5.

The lid 7 may be welded to the cylindrical can 2, for example by laser welding. In an alternative implementation, the lid 7 comprises a flange for arranging on an inside or around an outside of the brim of the open end of the cylindrical can 2.

As shown in FIGS. 1 and 2, the portion free of first electrode coating 4a on the first side 5a of the jelly roll 5 may be trimmed at a radially outmost part of said first side 5a. Accordingly, the part of the first side 5a of the jelly roll 5 that may abut the beading groove 3 during an axial displacement of the jelly roll 5 may be free from an uncoated portion so as to prevent undesired electrical contact therebetween. As mentioned above, the inner surface of the beading groove 3 may further comprise an insulating coating, such as a tape.

While the present disclosure is susceptible to various modifications and alternative forms, specific examples are shown and described in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims, including the possible combination of various elements of these specific examples.

1. A cylindrical secondary cell (1) comprising:
a cylindrical can (2) comprising a beading groove (3) formed in a wall of the cylindrical can (2) and arranged around the circumference of the cylindrical can (2),
a first conductive sheet (4), with first electrode coating (4a), wound to form a jelly roll (5) which is arranged in the cylindrical can (2), and wherein the first conductive sheet (4) comprises a portion free of first electrode coating (4a) which protrudes and axially extends from a first end side (5a) of the jelly roll (5) arranged below the beading groove (3), to a can connection surface above the beading groove (3),
wherein:
the can connection surface (9) is arranged at the first end side (5a) of the jelly roll (5) and configured to form an electrical connection from the jelly roll to the cylindrical can (2), by attachment of the can connection surface (9) to the portion of the first conductive sheet (4) free of first electrode coating (4a).

2. The cylindrical secondary cell according to claim 1, wherein the can connection surface is a current collector disc (6) or a lid configured to be attached to the cylindrical can to thereby close an open end of the cylindrical can.

3. The cylindrical secondary cell according to claim 1 wherein the connection surface is welded to the portion of the first conductive sheet (4) free of first electrode coating (4a).

4. The cylindrical secondary cell according to claim 1 wherein the current collector disc (6) is in direct contact with the lid and/or the cylindrical can (2).

5. The cylindrical secondary cell according to claim 1 wherein the jelly roll is axially retained within the cylindrical can by the beading groove.

6. The cylindrical secondary cell according to claim 1 wherein the current collector disc (6) and/or the lid comprises at least one through hole (6b) for electrolyte filling.

7. The cylindrical secondary cell according to claim 6, wherein the portion of the first conductive sheet (4) free of first electrode coating (4a) is configured to form one or more electrolyte channels.

8. A method for manufacturing the secondary cell according to claim 1 comprising:
arranging the can connection surface against the portion of the first conductive sheet (4) free of first electrode coating (4a); and
welding the can connection surface to the portion of the first conductive sheet (4) free of first electrode coating (4a).

9. The method according to claim 8, further comprising:
compressing the can connection surface against the portion of the first conductive sheet (4) free of first electrode coating (4a) to thereby form a folded welding surface for welding the can connection surface to the portion of the first conductive sheet (4) free of first electrode coating (4a).
